(19) United States
(12) Patent Application Publication
(10) Pub. No.: US 2001/0005862 A1
(43) Pub. Date: Jun. 28, 2001

(54) Method for down-loading data

(75) Inventor: Jun Souk Joung, Kyongki-do (KR)

Correspondence Address: FLESHNER & KIM, LLP, P. O. Box 221200, Chantilly, VA, 20153-1200, US

(73) Assignee: LG Electronics Inc.

(21) Appl. No.: 09/736,432

(22) Filed: Dec. 15, 2000

(30) Foreign Application Priority Data
Dec. 22, 1999 (KR) 60429/1999

(51) Int. Cl. G06F 15/177; G06F 15/16

(52) U.S. Cl. 709/250; 709/220; 717/11

(57) ABSTRACT

A program and a method is provided that simultaneously down-loads S/W programs or data onto a plurality of processors by using a multiplexing mode in a process of resetting the processors in a mobile communication switching system. The method can include requesting by a selected processor of the plurality of processors an information down-load from an upper processor, accessing a memory of the upper processor, determining whether the accessed information has an error or not, grouping the lower processors using a representative address, creating the accessed error free information in an IPC format and transferring the IPC format information using a grouped representative address. The programs or the data are down loaded at the same time onto the plurality of processors from the upper processor by using the multiplexing mode in the process of resetting the processors in the mobile communication switching system, which serves to reduce or minimize the shutdown of the system because of a rapid down-load completion.

### BACKGROUND OF THE INVENTION

1. Field of the Invention

The present invention relates to a method for down-loading data, and in particular, to a method for simultaneously down-loading data in a mobile communications system.

2. Background of the Related Art

In general, software (S/W) programs or data are down-loaded from a upper processor when resetting processors in a related art mobile communication switching system. A serial method used to down-load the S/W programs or the data when resetting processors in the related art mobile communication switching system is characterized by the complete down-load of the programs or the data onto a processor, and then, starting another down-load of the programs or the data onto the next processor.

In other words, if the S/W programs or the data are to be down-loaded onto a plurality of processors, one processor is completely down-loaded. Then, another processor is completely down-loaded from the upper processor. This process continues until a last processor of the plurality of processors is down-loaded with the S/W programs or the data.

FIG. 1 is a diagram that illustrates a related art signal flow directed from an upper processor to a plurality of lower processors. As shown in FIG. 1, if a lower processor selector vecoder controller (SVC) 0 requests (arrow 1) a upper processor communication control processor (CCP) for a data down-load, and another processor SVC 1 requests (arrow 2) the upper processor CCP for another data down-load before load completion (arrow 4) for the first load request, a load rejection (arrow 3) results. After the down-load requested by the lower processor SVC 0 is completed (arrow 4), if a lower processor SVC 2 requests (arrow 5) the upper processor CCP for an additional data down-load, the download (arrow 6) can be carried out since the down-load requested by the SVC 1 is completed (arrow 4). Then, if the lower processor SVC 1 requests the upper processor CCP for still another down-load (arrow 7), the down-load can be carried out (arrow 8) since there is not any conflicting lower processor request for a down-load.

FIG. 2 is a diagram illustrating a message format used when down-loading data from an upper processor onto lower processors according to both the related art and preferred embodiments according to the present invention. As shown in the message format of FIG. 2, data contained in a memory of the upper processor is formed into a message in an information processing code (IPC) format.

The IPC format includes a destination address of 4 bytes, a source address of 4 bytes, a type of 1 byte, a control of 1 byte, a signal ID of 2 bytes, a length of 2 bytes and a data of 200 bytes. The data contained in the memory of the upper processor is injected into the data of 200 bytes, which is an element of the IPC format.

As described above, the related art method for down-loading data has various disadvantages. In the related art method, the same contents being the S/W programs or the data are consecutively down-loaded onto the plurality of lower processors, which consumes a disadvantageously long time for the overall down-load. The return time is accordingly delayed in case of a system down.

The above references are incorporated by reference herein where appropriate for appropriate teachings of additional or alternative details, features and/or technical to background.

### SUMMARY OF THE INVENTION

An object of the invention is to solve at least the above problems and/or disadvantages and to provide at least the advantages described hereinafter.

Another object of the present invention is to provide a method for simultaneously down-loading data or S/W programs onto a plurality of processors.

Another object of the present invention is to provide a method for simultaneously down-loading data or S/W programs onto a plurality of processors by using a multiplexing mode in a process of resetting processors in a mobile communication switching system.

Another object of the present invention is to provide a method for simultaneously down-loading data or S/W programs onto a plurality of processors by using a multiplexing mode in a process of resetting processors in a mobile communication switching system that does not modify data definitions in a predefined information processing code format.

Another object of the present invention is to provide a method for simultaneously down-loading data or S/W programs onto a plurality of processors by using a multiplexing mode in a process of resetting processors in a mobile communication switching system that reduces or minimizes a shutdown time of a system through a rapid down-load.

To achieve at least the above objects in a whole or in part, there is provided a method for down-loading data onto a plurality of lower processors according to the present invention that includes requesting, in a lower processor, an information down-load to an upper processor; accessing a memory of the upper processor; determining whether the accessed information has an error or not; grouping the lower processors; and creating the accessed information in an IPC format and transmitting the same according to a grouped representative address.

According to preferred embodiments of apparatus and methods of the present invention, consequently, the programs or the data are simultaneously down-loaded onto the plurality of lower processors from an upper processor by using the multiplexing mode in the process of resetting the processors in the mobile communication switching system, thereby minimizing the shutdown of the system due to a rapid down-load realization.

To further achieve at least the above objects in a whole or in parts, there is provided a method for down-loading data from an upper processor to a plurality of lower processors of a mobile communications switching system in a process of resetting the processors, according to the present invention that includes requesting an information down-load from the lower processors to the upper processor, accessing a memory of the upper processor containing the requested information down-load, determining whether the accessed information has an error, grouping the lower processors with a representative address, and creating the accessed information in an IPC format and transferring the PC format information by using the group representative address.

To further achieve at least the above objects in a whole or in parts, there is provided a method for down-loading data from a first processor to a plurality of second processors while resetting the processors, according to the present invention that includes transmitting a request for an information down-load from the plurality of second processors to the first processor, accessing once a memory of the first processor for the requested information, grouping the second processors using a prescribed processor address, and assembling the accessed information and transferring the assembled requested information to at least two second processors using a group representative address.

Additional advantages, objects, and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

### BRIEF DESCRIPTION OF THE DRAWINGS

The invention will be described in detail with reference to the following drawings in which like reference numerals refer to like elements wherein:

FIG. 1 is a time sequencing diagram illustrating a signal flow directed from an upper processor to lower processors according to the related art;

FIG. 2 is a diagram illustrating a process for transforming data contained in a memory of an upper processor into a message in an information processing code format;

FIG. 3 is a block diagram illustrating a preferred embodiment of a process for grouping lower processors with a same group address by using a representative address according to the present invention; and

FIG. 4 is a flow chart illustrating a preferred embodiment of a process for down-loading programs or data while resetting processors according to the present invention.

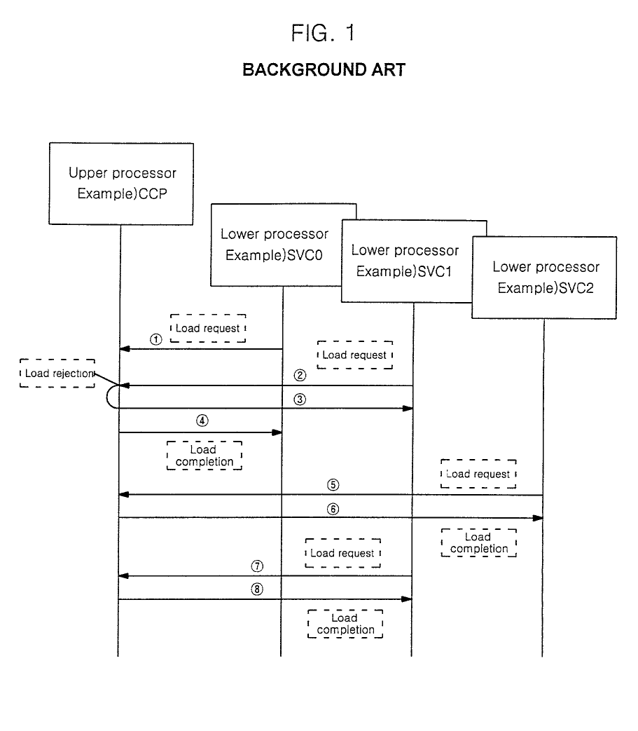

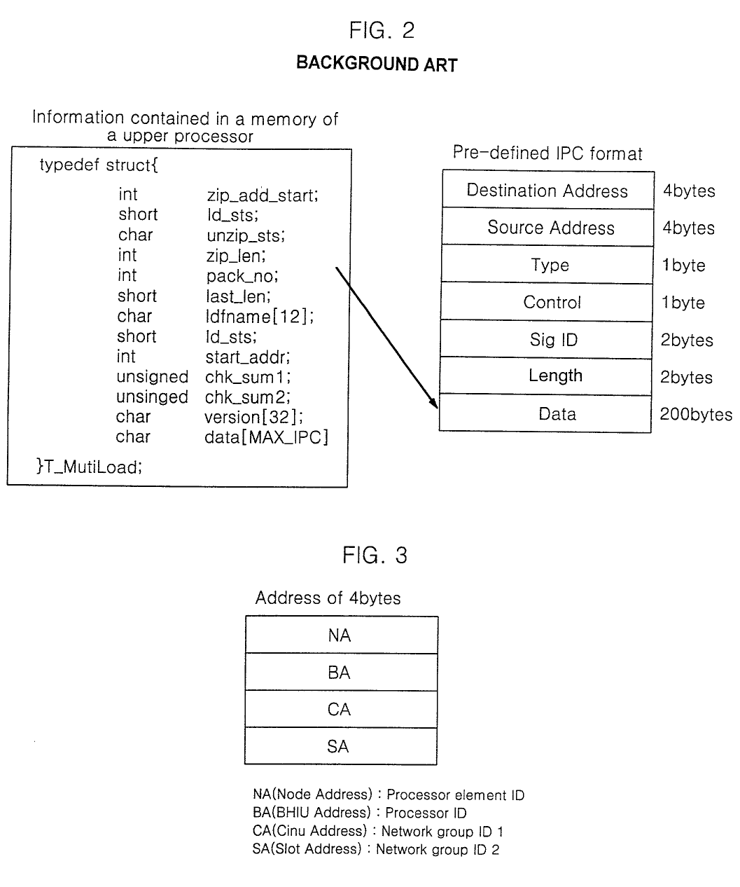

### DETAILED DESCRIPTION OF PREFERRED EMBODIMENTS

Preferred embodiments of the present invention will now be described with reference to the accompanying drawings. Preferred embodiments of methods/apparatus according to the present invention are based on a process transferring data or S/W programs, which are to be down-loaded onto processors, by using a multiplexing mode. The multiplexing mode down-load is preferably characterized by a single access of a specific memory where the S/W programs or the data are loaded, creating the accessed information in a preferably pre-defined information processing code (IPC) format, and transferring the S/W programs or the data having the same contents to a plurality of processors to be reset through a single-transfer manner or operation. The single-transfer operation, in general, signifies that the plurality of processors and addresses of the processors as well as the representative address of the processors are pre-defined suitable for the IPC format so that messages can be delivered to the plurality of processors through only a single-transfer operation by using the IPC format.

FIG. 3 is a diagram illustrating a preferred embodiment of a method for grouping lower processors with identical group address by using a representative address, which is used for down-loading S/W programs or data onto the plurality of lower processors from an upper processor at the same time according to preferred embodiments of the present invention. The plurality of processors have their own prescribed address of 4 bytes. The prescribed address of the plurality of processors preferably includes four elements, each being 1 byte in length. Among the respective elements, a node address (NA) of 1 byte represents a process element ID, a BHIU address (BA) of 1 byte represents a processor ID, a cinu address (CA) of 1 byte represents a network group ID1, and a slot address (SA) of 1 byte represents a network group ID2.

For example, assume respective processor information that includes the above elements is the following: NA:0/BA: 1/CA2/SA2 in case of an A processor; NA:3/BA:4/CA1/SA2 in case of a B processor; NA:0/BA:6/CA2/SA2 in case of a C processor; and NA:0/BA:1/CA1/SA2 in case of a D processor of a plurality of lower processors. In this example, the method for grouping the representative address is preferably performed with the CA information and the SA information.

Thus, according to the above processor information, the processors A and C are grouped by an identical group address (e.g., CA2), while the processors B and D are grouped by a different identical group address (e.g., CA1).

To be specific, the representative address grouping the processors A and C is determined to be NAFE BAFF CA2 SA2, whereas the representative address grouping the processors B and D is determined to be NAFF BAFF CA1 SA2. In a similar manner described above, according to the preferred embodiments, the grouping can be performed with both the CA information and the SA information, just the CA information or just the SA information.

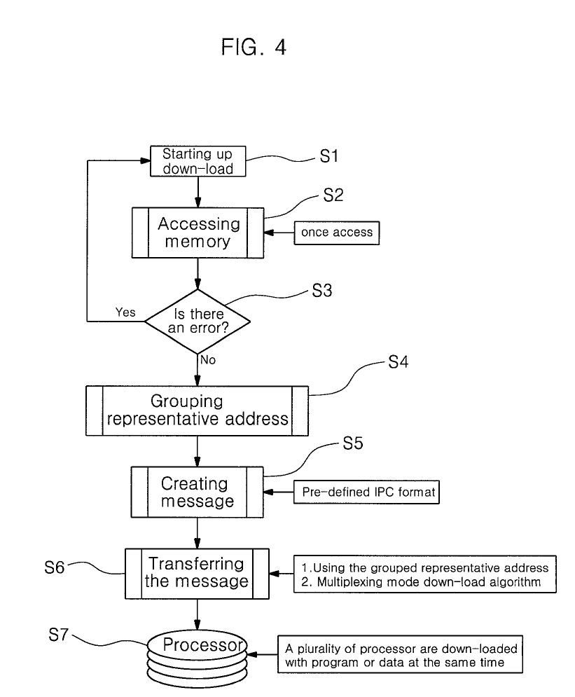

FIG. 4 is a flow chart illustrating a preferred embodiments of a method for down-loading programs or data in a process of resetting processors in a mobile communication switching system. As shown in FIG. 4, the preferred embodiments of the method for down-loading the S/W programs or the data from an upper processor onto a plurality of lower processors in the process of resetting the processors in the mobile communication switching system preferably starts in step S1, where a lower processor requests the upper processor for an information down-load. From step S1, control continues to step S2 where the upper processor accesses once a memory containing the data to be transferred to the lower processor. From step S2, control continues to step S3, where it is determined whether the single memory access has an error. If the determination in step S3 is an error was detected, control returns to step S1.

If the determination in step S3 is no error, control continues to step S4 where the grouping is conducted according to the representative address preferably according to the defined processor address as shown in FIG. 3. From step S4, control continues to step S5 where a message is created preferably in the pre-defined IPC data format.

From step S5, control continues to step S6 where the representative address grouping the lower processors are injected into the message created in the pre-defined IPC data format, which is transferred to a pertinent address for a multiplexing mode down-load. The plurality of processors within the grouped address, which generally receive messages transmitted to the grouped representative address, receive the transmitted IPC format message so as to down-load the programs or the data. Thus, in step S7, the plurality of processors can down-load the programs or the data at the same time, which reduces a required time for resetting the processors in a mobile communication switching system. Further, additional system changes are not incurred.

The representative address grouping the lower processors are injected into the created message, which is transferred to a pertinent address for the multiplexing mode down-load in step S6. The method for the multiplex mode downloading the programs or the data of the same contents onto the plurality of lower processors preferably includes the steps of grouping the plurality of lower processors to be down-loaded with the same group address, converting the message to be transferred to the representative address into the IPC format when down-loading the S/W programs or the data from the upper processor onto the lower processor then transferring the converted message, and receiving the IPC format message transmitted from the upper processor by the plurality of lower processors within the same group so as to down-load the programs or the data. Accordingly, transfer the S/W programs or the data of the same contents to the plurality of processors through a once-transfer manner.

As shown in FIG. 4, the multiplexing mode down-load is used in the mobile communication switching system to group the plurality of processors with the same group address. For example, if an upper processor CCP is requested for a down-load from 15 pertinent lower processor 15 SVCs, the CCP accesses once a specific memory containing programs to be down-loaded onto the pertinent SVCs, and converts the contents of the memory into the pre-defined IPC format. Here, the representative address of the grouped SVCs is set to be transferred. The plurality of SVCs, namely lower processors, simultaneously receive the down-loaded programs and then concurrently start up.

As described above, the preferred embodiments of methods for down-loading the programs or the data having the same contents onto the plurality of lower processors can include grouping the plurality of lower processors using a representative address to be down-loaded with the same group address, converting the message to be transferred to the representative address into the IPC format when down-loading the S/W programs or the data from the upper processor onto the lower processor, transferring the converted message and receiving the IPC format message, which was transmitted from the upper processor, by the plurality of lower processors within the same group so as to all down-load the programs or the data.

As described above, preferred embodiments of methods for down-loading S/W programs or data from a first processor to a plurality of additional processors according to the present invention have various advantages. The first processor performs a single access for the down-loaded S/W programs or the data. Accordingly, a process time is reduced. Each of the additional processors do not perform a specific request of the first processor for the down-loaded S/W programs or the data. The plurality of additional processors can each directly start operating the same down-loaded S/W program or data. Accordingly, a time for resetting processors in a mobile communications switching system can be reduced or minimized without altering a prescribed information processing code (IPC) format using the preferred embodiments.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures.

What is claimed is:

1. A method for down-loading data from an upper processor to a plurality of lower processors of a mobile communications switching system in a process of resetting the processors, the method comprising:
requesting an information down-load from the lower processors to the upper processor;
accessing a memory of the upper processor containing the requested information down-load;
determining whether the accessed information has an error;
grouping the lower processors with a representative address; and
creating the accessed information in an IPC format and transferring the IPC format information by using the group representative address.

2. The method of claim 1, wherein the resetting of the processors includes an initial loading and a re-loading.

3. The method of claim 1, wherein the group representative address includes all the lower processors.

4. The method of claim 1, wherein the grouping the lower processors comprises grouping the plurality of lower processors using the group representative address.

5. The method of claim 1, wherein the grouping the lower processors comprises grouping at least one additional lower processor.

6. The method of claim 1, wherein group information is used to determine the group representative address, and wherein the group information comprises a node address (NA), a BHIU address (BA), a cinu address (CA), and a slot address (SA).

7. The method of claim 6, wherein the group representative address is set by using the CA and the SA among the group information.

8. The method of claim 7, wherein grouping of the group representative address is responsive to one of only the CA among the group information, only the SA among the group information and both the CA and the SA among the group information.

9. The method of claim 8, wherein the IPC format information is concurrently transferred to all the lower processors using the group representative address.

10. A method for down-loading data from a first processor to a plurality of second processors while resetting the processors, the method comprising:
transmitting a request for an information down-load from the plurality of second processors to the first processor;
accessing once a memory of the first processor for the requested information;
grouping the second processors using a prescribed processor address; and
assembling the accessed information in a prescribed format and transferring the assembled requested information to at least two second processors using a group representative address.

11. The method of claim 10, wherein the grouping of the plurality of lower processors is performed using the group representative address.

12. The method of claim 10, wherein the prescribed processor address is an IPC processor address that includes a node address (NA), a BHIU address (BA), a cinu address (CA), and a slot address (SA).

13. The method of claim 12, wherein the group representative address is set by using the CA and the SA among the IPC processor address.

14. The method of claim 13, wherein grouping of the group representative address is responsive to one of the CA, the SA and both the CA and the SA.

15. The method of claim 10, wherein the method further comprises determining whether the accessed requested information has an error.
